(19) United States
(12) Patent Application Publication
(10) Pub. No.: US 2007/0207308 A1
(43) Pub. Date: Sep. 6, 2007

(54) Hollow Structure Member, Heat Insulating Member, and Buffering Member

(75) Inventor: Toshiaki Marumoto, Kanagawa (JP)

Correspondence Address: KUBOVCIK & KUBOVCIK, SUITE 710, 900 17TH STREET NW, WASHINGTON, DC, 20006, US

(73) Assignee: Idea Kogyo Ltd

(21) Appl. No.: 10/592,686

(22) PCT Filed: Mar. 9, 2005
(86) PCT No.: PCT/JP05/04054

§ 371 Date: Apr. 3, 2007

(30) Foreign Application Priority Data
Mar. 18, 2004 (JP) 2004-077592

(51) Int. Cl. B32B 3/26

(52) U.S. Cl. 428/314.4

(57) ABSTRACT

[Object]A hollow structure member having an air layer of a substantially uniform thickness to improve heat insulating performance and shock absorbing performance and cable of being folded into a smaller bulk in an exhausted state of gas. [Means for Solving the Problem]

Two sheet members (11, 12) constitute at least a part of a hermetically sealed structure and disposed face to face with each other, and a gas-permeable sheet member (13) has gas permeability and joined alternately to opposed surfaces of the two sheet members (11,12), and the two sheet members may be joined together at end edges thereof to form a hollow body.

### TECHNICAL FIELD

The present invention relates to a hollow structure member superior in heat insulating property and shock absorbing property. In particular, the present invention is concerned with a hollow structure member comprising two sheets and a gas layer such as, for example, air layer, present between the two sheets.

### BACKGROUND ART

Known hollow structure members each used as a heat insulating and buffer member and having an air layer as referred to above are shown in FIGS. 9 to 11.

In a hollow structure member 60 shown in FIG. 9, a sheet 62 for forming air chambers is welded onto a planar base sheet 61 so as to form joining line portions 64 at predetermined intervals to form plural air chambers 63 with air sealed therein side by side between the base sheet and the other sheet. The hollow structure member 60 is known as an air-bubble buffer sheet having heat insulating property and shock absorbing property.

In a hollow structure member 70 shown in FIG. 10, two sheets 71 and 72 are formed with welded portions 74 at predetermined intervals, allowing air to be sealed in between the welded portions.

Further, in a hollow structure member 80 shown in FIG. 11, plural spongy spacers 83 are sandwiched in between two sheets 81 and 82 to ensure a predetermined distance between the two sheets 81, 82, thereby forming air chambers 84.

In each of the above three examples, the peripheral edge of the hollow structure member are such that the constituent sheets are welded together or are connected with each other through another member. Thus, the hollow structure member as a whole is formed as a plate member having a predetermined thickness.

### DISCLOSURE OF THE INVENTION

Problem to be Solved by the Invention

However, in each of the above first and second hollow structure members 60, 70, air layer-free portions occur because the two sheets are connected together at their welded portions. Consequently, the thermal efficiency is deteriorated markedly at the air layer-free portions, and in a certain temperature condition the thermal efficiency of the portions in question becomes still worse due to the formation of dew or ice.

The third hollow structure member 80 described above has a certain air layer thickness, but involves the problem that it is impossible to withdraw air from the air chambers and fold the hollow structure member into a smaller bulk.

It is an object of the present invention to solve the above-mentioned problems and provide a hollow structure member having an air layer of a substantially uniform thickness to improve heat insulating performance and shock absorbing performance and cable of being folded into a smaller bulk in an exhausted state of gas.

Means for Solving the Problem

The hollow structure member according to the present invention comprises two sheet members constituting at least a part of a hermetically sealed structure and disposed face to face with each other and a gas-permeable sheet member having gas permeability and joined alternately to opposed surfaces of the two sheet members.

In the hollow structure member according to the present invention, the two sheet members may be joined together at end edges thereof to form a hollow body. A gas supply port for the supply and discharge of gas may be formed. Further, in each of the joined portions between the sheet members and the gas-permeable sheet member there may be disposed a reinforcing sheet for enhancing the joining force between the associated sheet member and the gas-permeable sheet member.

The heat insulating member according to the present invention is provided with the above hollow structure member as a heat insulating portion. The buffer member according to the present invention is provided with the above hollow structure member as a buffer portion.

### EFFECT OF THE INVENTION

In the hollow structure member according to the present invention, a gas-permeable sheet member having gas permeability is disposed between two opposed sheet members so as to be joined alternately to opposed surfaces of the two sheet members, so in a sealed state of gas between the sheet members, the gas permeates through the gas-permeable sheet member. As a whole, therefore, a single air layer is formed between the two sheet members and the thickness of the air layer is set almost constant in accordance with the joining size between the sheet members and the gas-permeable sheet member. Thus, a local thinning does not occur and it is possible to attain a substantially uniform thickness.

In the hollow structure member according to the present invention, since the two sheet members are joined together at end edges of the hollow body, it is possible to ensure a hermetically sealed structure as a whole.

In the hollow structure member according to the present invention, since a gas supply port for the supply and discharge of gas is formed, not only a gas layer of a nearly constant thickness can be formed stably while the interior of the hollow structure member is filled with the gas, but also the hollow structure member becomes sheet-like in an exhausted state of the interior gas and therefore can be stowed in a thin and small folded state.

In the hollow structure member according to the present invention, since a reinforcing sheet for enhancing the joining force between the sheet members and the gas-permeable sheet member is disposed in each of the joined portions between the sheet members and the gas-permeable sheet member, the joining force between the sheet members and the gas-permeable sheet member is improved.

The heat insulating member according to the present invention can have an air layer of a nearly constant thickness and exhibit an excellent heat insulating effect because it is provided with the above hollow structure member as a heat insulating portion.

The buffer member according to the present invention exhibits an excellent shock absorbing effect because it is provided with the above hollow structure member as a buffer portion.

### BEST MODE FOR CARRYING OUT THE INVENTION

The hollow structure member, heat insulating member and buffer member according to the present invention will be described below by way of embodiments.

### Embodiments

FIG. 1 shows an embodiment of the hollow structure member-according to the present invention, in which (a) is a sectional view and (b) is a plan view, and FIG. 2 is a sectional perspective view of the hollow structure member shown in FIG. 1. In this embodiment, a hollow structure member 10 comprises two airtight sheet members 11 and 12 of a rectangular shape and a gas-permeable sheet member 13 of a rectangular shape disposed between the sheet members 11 and 12. The sheet members 11 and 12 are formed of a thermoplastic resin such as, for example, polyvinyl chloride and are joined together by heat-welding at peripheral joining line portions 17 as in FIG. 1(b) to form a gas chamber 18 in a hermetically sealed state. A gas supply port 14 is formed in the sheet member 11 to permit the supply and discharge of air into and from the air chamber 18 formed inside the sheet members 11 and 12.

The sheet members 11 and 12 are not specially limited insofar as they are airtight as a whole and may each be, for example, polyethylene sheet, polyester sheet, heat insulating sheet, rubber sheet, rubber-coated cloth, or resin-coated cloth. The method for joining the outer edges of the sheet members 11 and 12 is not limited to heat-welding, but may be bonding or any other means insofar as air-tightness is ensured.

The gas-permeable sheet member 13 is a mesh sheet of a polyester resin, permitting gas to pass therethrough easily. As the gas-permeable sheet member 13 there may be used, for example, mesh sheet formed of a synthetic resin, non-woven fabric, lace sheet, sheet which is lattice-like or has punched holes, or cloth formed of a synthetic or natural fiber.

In this embodiment, as shown in FIGS. 1 and 2, the gas-permeable sheet 13 is joined by heat-welding alternately at joining line portions 15 and 16 to opposed surfaces of the two sheet members 11 and 12 which are disposed face to face with each other. In this embodiment, as shown in FIG. 3, the heat-welding is performed through reinforcing sheets 19 along the joining line portions 15 and 16 to enhance the joining strength. The reinforcing sheets 19 may be omitted if desired.

According to this embodiment, in a sealed state of gas between the sheet members, the gas passes through the gas-permeable sheet and, as a whole, a single air layer is formed between the two sheet members. Besides, since the thickness of the air layer is set almost constant in accordance with the joining size between the sheet members and the gas-permeable sheet, a local thinning does not occur and it is possible to obtain a hollow structure member of a substantially uniform thickness having large heat insulating power and shock absorbing power. Moreover, since the gas supply port is formed, not only a gas layer of a nearly constant thickness can be formed stably while the interior of the hollow structure member is filled with the gas, but also in an exhausted state of the interior gas the hollow structure member becomes sheet-like and hence can be folded and stowed thin and small.

The hollow structure member 10 thus fabricated is employable as a sheet-like heat-insulation member, cold-insulation member or buffer member because it is superior in heat insulating power and shock absorbing power.

The following description is now provided about what effect is obtained by using such a hollow structure member as a heat insulating member. FIG. 4 is a graph showing the results of a first simulation using the hollow structure member of the embodiment, FIG. 5 is a graph showing the results of a second simulation using the hollow structure member of the embodiment, and FIG. 6 is a graph showing the results of a third simulation using the hollow structure member of the embodiment.

A conventional hollow structure member of the construction shown in FIG. 10 and having the following dimensions there was used in the simulations:

| | |
|---|---|
| Sheet thickness, t: | 0.4 mm |
| Sheet material: | polyvinyl chloride, |
| | polyester resin |
| Air layer thickness, D: | 50 mm |
| Width, w, of air-free portion: | 2 mm |
| Pitch, p, of air-free portion: | 80 mm |

The hollow structure member according to the embodiment of the present invention was of the construction shown in FIG. 1 and had the following dimensions:

| | |
|---|---|
| Sheet thickness: | 0.4 mm |
| Sheet material: | polyvinyl chloride, |
| | polyester resin |
| Air layer thickness: | 50 mm |

Further, the following conditions were adopted as common conditions:

| | |
|---|---|
| Air: | large volume quantity, |
| | no change in temperature |
| Thermally insulated (cold-insulated) liquid: | water |
| Thermally insulated (cold-insulated) area: | 1 m² (square meter) |
| Length of air-free portion in the conventional | 840 mm (1000 − 2 × 80) |
| thermal insulator: | |
| Depth of thermally insulated (cold insulated) | |
| liquid: | |

The depth was set very small and the thermal insulator (cold insulator) liquid-side inner wall temperature was calculated as an internal temperature.

In the first simulation shown in FIG. 4, each hollow structure member was placed in between warm water of 40° C. and air of 20° C. This corresponds to the case where warm water is stored in a bathtub and a heat insulating lid is allowed to float thereon for thermal insulation.

In the second simulation shown in FIG. 5, each hollow-structure was placed in between hot water of 90° C. and air of 0° C. This corresponds to the case where the heat of hot water for drinking is insulated in cold air.

In the third simulation shown in FIG. 6, each hollow structure was placed in between cold water of 5° C. and air of 30° C. This corresponds to the case where-cold water for drinking is cold-insulated in the outside air.

It turned out that in all of the simulations the hollow structure member according to the embodiment was effective 30% or more with respect to thermal conductivity (Kcal/m²·h·° C.) in comparison with the conventional hollow structure member and was superior in both thermal insulation property and cold insulation property.

FIG. 7 shows an example in which the hollow structure member shown in FIG. 1 is used as a bathtub lid so as to serve as a heat insulating member, in which (a) is a sectional view and (b) is a plan view. In the illustrated example, three lid members 21, 22 and 23 are arranged side by side to constitute a bathtub lid 20. In this example, the lid members 21, 22 and 23 are arranged over warm water stored in a bathtub to prevent contact of the warm water surface with air. As in the above first simulation (FIG. 4), the warm water can be insulated for a longer time than in the conventional hollow structure member.

FIG. 8 is a sectional view showing an example in which the hollow structure member shown in FIG. 1 is used as a container for a drinking water PET bottle. According to the container, indicated at 50, of this example, a bag-like cubic hollow chamber member having a gas chamber 44 is formed by two sheet members 41, 42 and a gas-permeable sheet 43 so that a PET bottle for drinking water can be housed within the container. The numeral 45 in the figure denotes a sealing member provided in the mouth of the container 50. The sealing member 45 can be opened and closed to bring the interior of the container into a hermetically seated state. According to this example, when warm drinking water is placed into the PET bottle, a high thermal insulation performance is exhibited as in the foregoing second simulation (FIG. 5) as compared with the conventional hollow structure member. When cold drinking water is placed into the PET bottle, an excellent cold insulation performance is exhibited as in the foregoing third simulation (FIG. 6).

Although the container of this example has been described as having both thermal and cold insulation properties, the container also acts as a buffer container to protect the inside article from a shock. When the container is used as such a buffer container, a suitable shape thereof can be selected to match the shape of the article housed within the container.

Although the air layer formed in the above hollow structure member is a single layer, the air chamber may be formed as a double or more layers.

The hollow structure member according to the present invention is employable as any of, for example, bathtub lid, automobile glass anti-freezing sheet, automobile body cover, clothes for cold weather, anti-frost sheet, heat-insulation sheet, heat-insulation bag, nursing bottle heat-insulation bag, pots/pans heat-insulation bag, rice-tub heat-insulation bag, heat-insulation tube, life jacket, dew preventing sheet, tent, heat shielding sheet, anti-freezing sheet, vinyl house, float, boat, cold-insulation conveyance bag for fresh food, bag for the storage of art works, bag for the storage of tableware, bag for the storage of clothes, bag for the conveyance of electronic and electric devices, bag for the conveyance of precision devices, cap/hat storage bag, shoes storage bag, bag for the conveyance of eggs, and camera case.

Moreover, in each of the above examples, since the hollow structure member can be brought into a gas-exhausted state, an advantage that a small space suffices for the storage thereof is provided. Further, since the hollow structure member, except the gas supply port, is free of minute concaves and convexes, the hollow structure member is difficult to be stained and the extraction and washing thereof can be done easily. Additionally, in case the hollow structure member is discharged to waste due to a secular change or a serious damage, the volume of the waste can be reduced because such a heat insulating material as glass wool or synthetic resin is not used.

### BRIEF DESCRIPTION OF THE DRAWINGS

FIG. 1 is a diagram showing a hollow structure member according to an embodiment of the present invention, in which (a) is a sectional view and (b) is a plan view.

FIG. 2 is a sectional perspective view of the hollowing structure member shown in FIG. 1.

FIG. 3 is an enlarged sectional view of a hollow structure member according to a modification of the embodiment.

FIG. 4 is a graph showing the results of a first simulation using the hollow structure member of the embodiment.

FIG. 5 is a graph showing the results of a second simulation using the hollow structure member of the embodiment.

FIG. 6 is a graph showing the results of a third simulation using the hollow structure member of the embodiment.

FIG. 7 is a diagram showing an example of using the hollow structure member of FIG. 1 as a bathtub lid, in which (a) is a sectional view and (b) is a plan view.

FIG. 8 is a sectional view showing an example of forming a sealing portion able to open and close in the hollowing structure member of FIG. 1 and using the hollow structure member as a cold-insulation bag for a drinking water PET bottle.

FIG. 9 is a sectional view showing a conventional hollow structure member.

FIG. 10 is a sectional view showing another conventional hollow structure member.

FIG. 11 is a sectional view showing a further conventional hollow structure member.

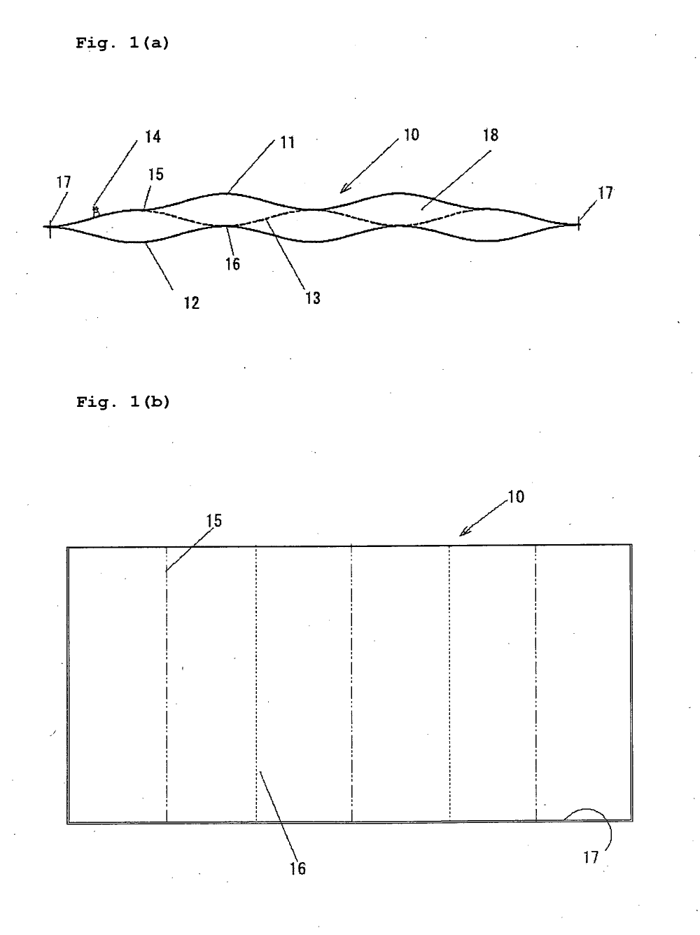

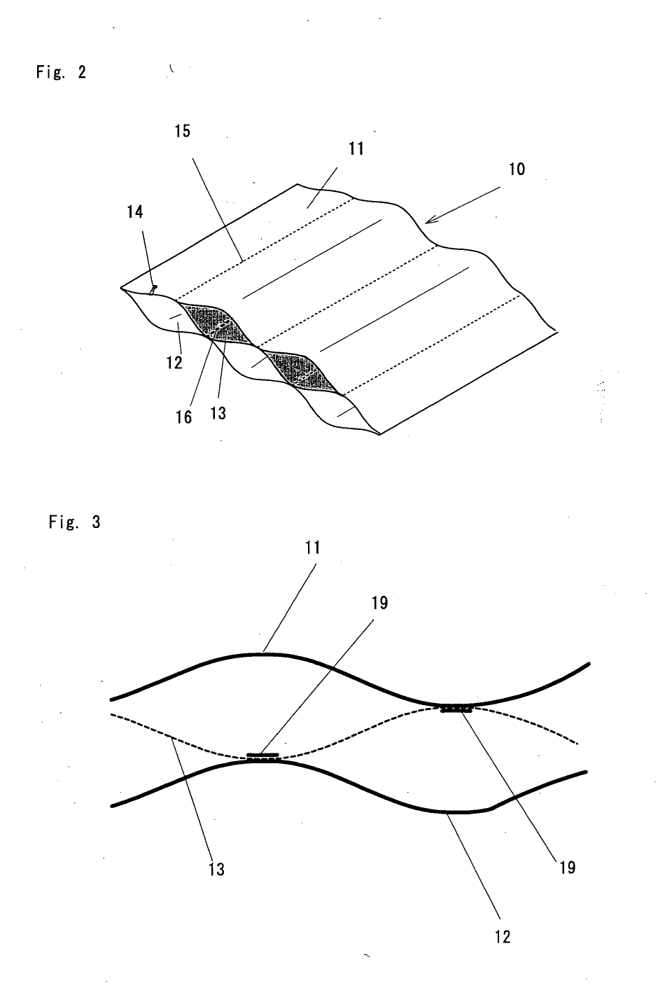

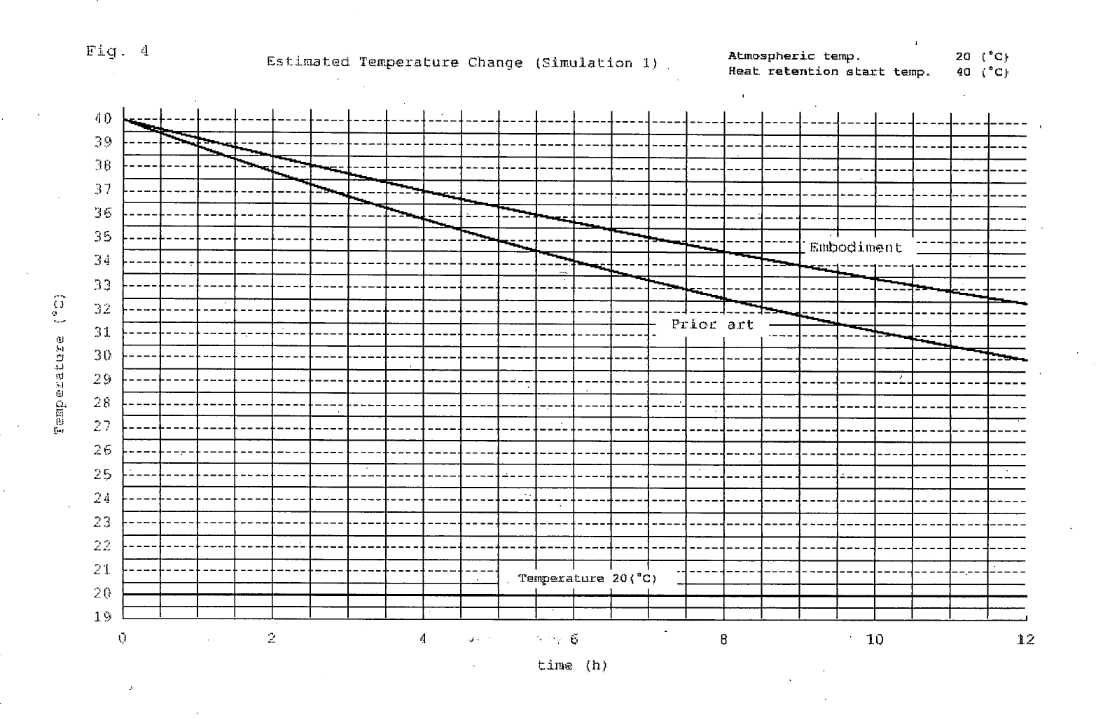

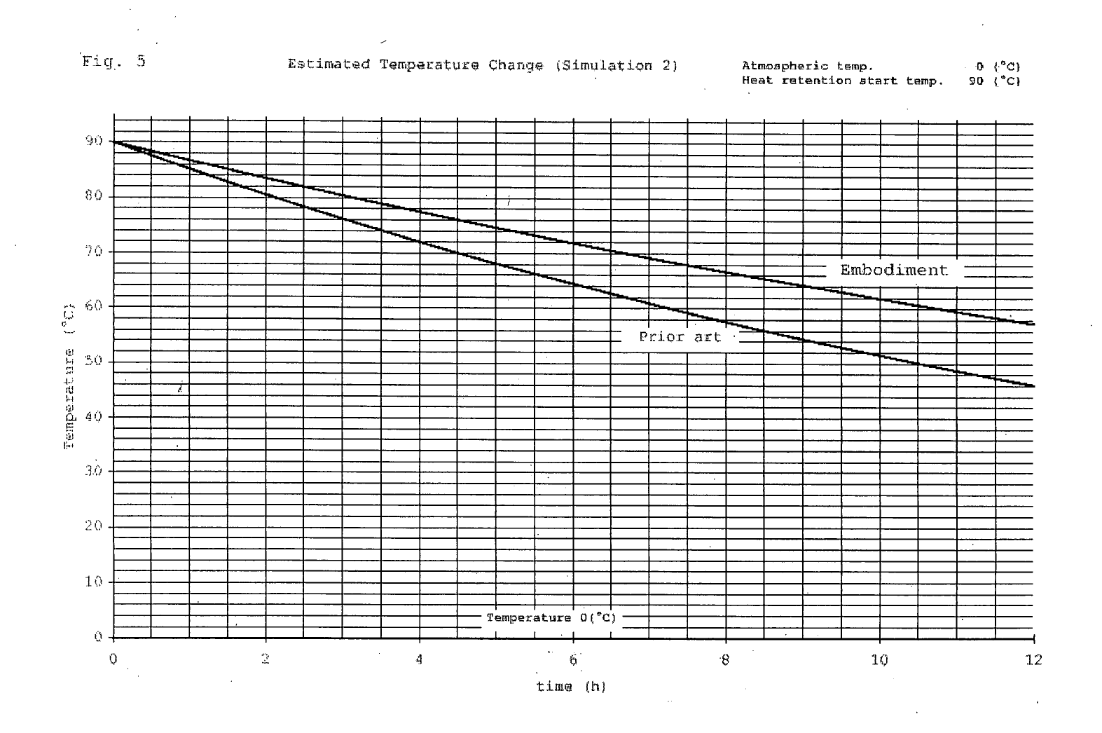

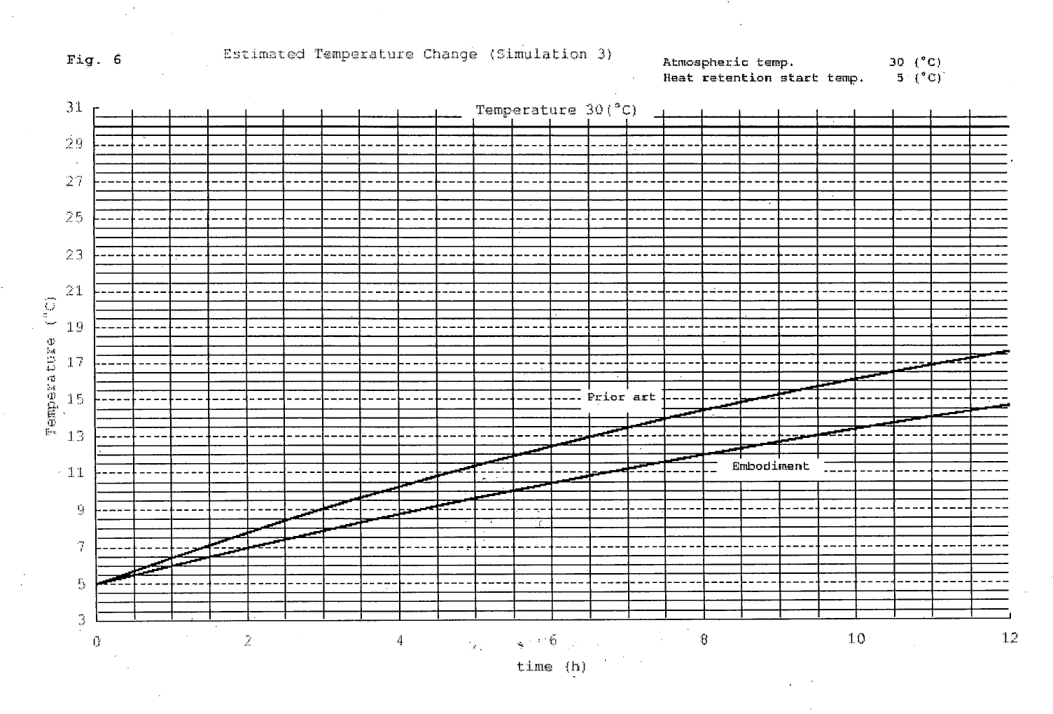

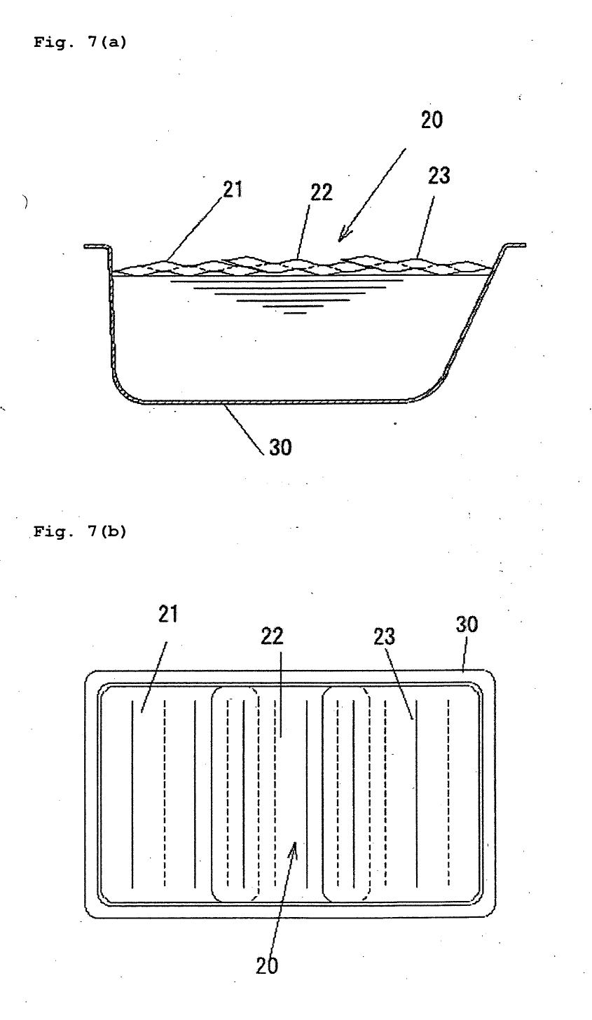

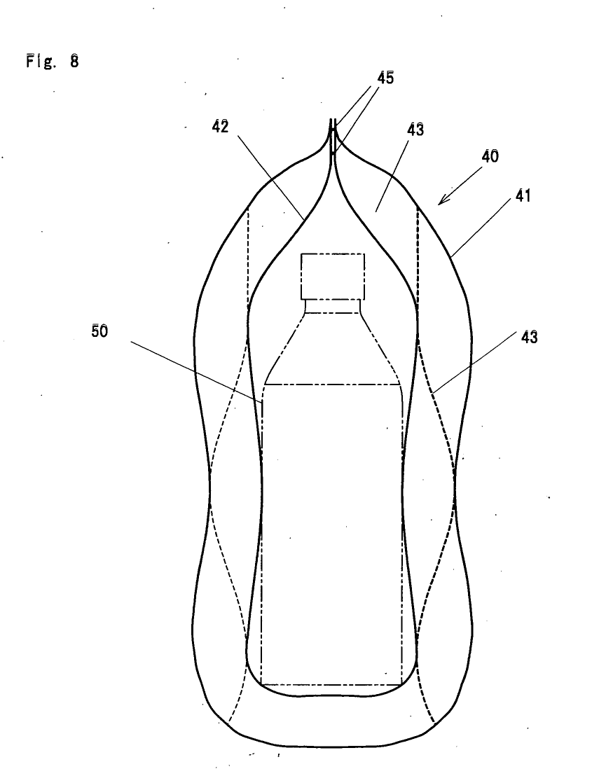

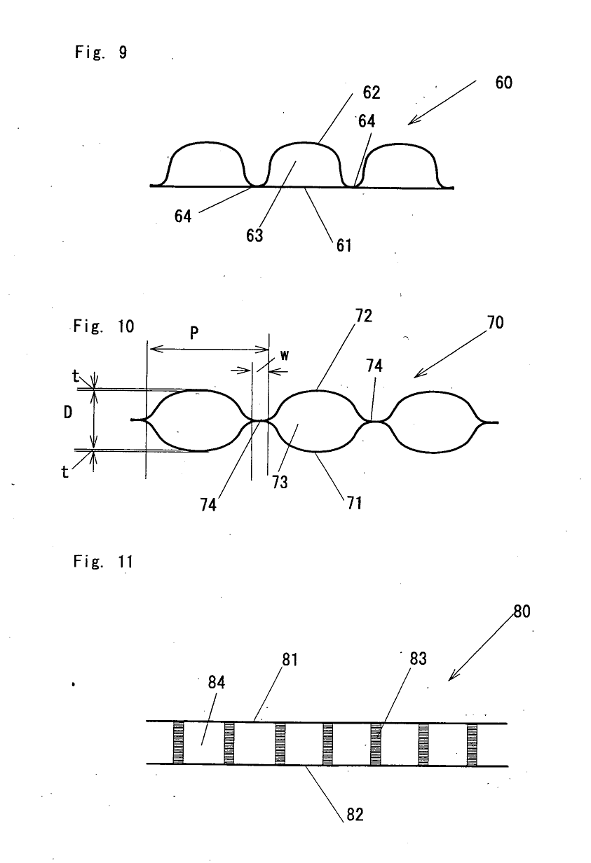

### EXPLANATION OF REFERENCE NUMERALS

10 hollow structure member
11 sheet member
12 sheet member
13 gas-permeable sheet member
14 gas supply port
15 welded portion
16 welded portion
17 peripheral welded portion
18 gas chamber
19 reinforcing sheet
20 bathtub lid
21 lid member
22 lid member
23 lid member
30 bathtub
40 cold-insulation container
41 sheet member
42 sheet member
43 gas-permeable sheet member
44 gas chamber
45 sealing portion
50 PET bottle

1. A hollow structure member comprising:
two sheet members constituting at least a part of a hermetically sealed structure and disposed face to face with each other; and
a gas-permeable sheet member having gas permeability and joined alternately to opposed surfaces of said two sheet members.

2. A hollow structure member according to claim 1, wherein said two sheet members are joined together at end edges thereof to form a hollow body.

3. A hollow structure member according to claim 1, having a gas supply port for the supply and discharge of gas.

4. A hollow structure member according to claim 1, wherein a reinforcing sheet for enhancing the joining force between said sheet members and said gas-permeable sheet member is disposed in each of the joined portions between the sheet members and the gas-permeable sheet member.

5. A heat insulating member having the hollow structure member of claim 1 as a heat insulating portion.

6. A buffer member having the hollow structure member of claim 1 as a buffer portion.
